(19) United States
(12) Patent Application Publication
(10) Pub. No.: US 2024/0042363 A1
(43) Pub. Date: Feb. 8, 2024

(54) GAS FILTERS COMPRISING A MATRIX MATERIAL AND A CARBON DIOXIDE SORBENT

(71) Applicant: UNIVERSITY OF BATH, Claverton Down, Bath (GB)

(72) Inventors: Semali Priyanthi PERERA, Claverton Down, Bath (GB); Barry David CRITTENDEN, Claverton Down, Bath (GB); Olivier CAMUS, Claverton Down, Bath (GB); Yong-Min CHEW, Claverton Down, Bath (GB); Ramya G, Claverton Down, Bath (GB)

(21) Appl. No.: 18/255,944

(22) PCT Filed: Dec. 7, 2021
(86) PCT No.: PCT/GB2021/053197

§ 371 Date: Jun. 5, 2023

(30) Foreign Application Priority Data
Dec. 8, 2020 (GB) 2019318.1

(51) Int. Cl. B01D 46/00; B01D 39/16; B01D 39/20; B01D 53/62

(52) U.S. Cl. CPC B01D 46/0036; B01D 39/1676; B01D 39/2075; B01D 53/62; B01D 2239/0266; B01D 2253/202; B01D 2239/1216; B01D 2253/104; B01D 2253/1124; B01D 2253/11; B01D 2257/504

(57) ABSTRACT

The present invention provides a gas filter comprising an active element and a housing structure for said active element, said housing structure comprising a gas inlet and a gas outlet, said active element comprising or consisting of: a matrix material; a CO₂ sorbent; and water, wherein at least some of the CO₂ sorbent is embedded within the matrix material.

### FIELD OF THE INVENTION

The present invention relates to gas filters, methods of making and uses thereof. More particularly, the present invention relates to air filters, methods of making and uses thereof. In particular, the filters may be used for removing carbon dioxide (CO₂) from gas streams or air streams. The present invention also relates to active elements suitable for use in said gas (air) filters, methods of making and uses thereof.

### BACKGROUND OF THE INVENTION

The perceived problems associated with excess amounts of carbon dioxide in the environment are well known. There is a significant and on-going need for methods to reduce levels of carbon dioxide in the atmosphere and from various other environments such as exhaust gases or waste gases generated in industry, business or in the home, and more generally in enclosed environmental spaces, e.g. in cars and offices. The present invention sets out to address these problems.

### SUMMARY OF THE INVENTION

In a first aspect of the present invention, there is provided a gas filter comprising an active element and a housing structure for said active element, said housing structure comprising a gas inlet and a gas outlet, said active element comprising or consisting of: a matrix material; a CO₂ sorbent; and water, wherein at least some of the CO₂ sorbent is embedded within the matrix material.

The gas (e.g. air) filters in accordance with the present invention are suitable for use in various environments or applications including in the health industry and the transport industry, for example in the airline and automotive industries. The air filters may be used in aircraft cabins or automobile cabins, including in car and lorry cabins. For example, they may be used in electric car air systems. The air filters may be used in breathing apparatus, industrial waste gas stacks, fume cupboards, air purifiers, heating, ventilation, and air conditioning (HVAC) systems, and diving rebreathers.

In a second aspect, there is provided a method of removing carbon dioxide from a gas stream comprising passing the gas stream through the gas filter in accordance with the first aspect of the present invention. The gas stream enters the gas filter at the gas inlet, passes through the matrix material, contacts the CO₂ sorbent and exits the gas filter at the gas outlet. The level of carbon dioxide is reduced following passage through the air filter and contact with the CO₂ sorbent. In the method of the invention, the gas filter may be heated in order to activate said filter. For example, where the CO₂ sorbent comprises, consists of, or consists essentially of an alkali metal carbonate, during use the alkali metal carbonate is converted at least partly to the corresponding alkali metal bicarbonate. By applying heat, the alkali metal bicarbonate is converted back to the corresponding alkali metal carbonate. The gas filter may be manufactured in either an “active” or “inactive” state or form. For example, the gas filter may be initially produced wherein the matrix material comprises bicarbonate. For the situation when only bicarbonate is present and no carbonate, the gas filter may be described herein as being in the inactive form. For the situation when only carbonate is present and no bicarbonate, the gas filter may be described herein as being in the active form. For the situation wherein there is both carbonate and bicarbonate present, the gas filter may be described as being in an active or partially active form.

In a third aspect, there is provided the active element as referred to in the first aspect of the invention. As such, the present invention extends to an active element suitable for use in the first and second aspects of the invention.

In a fourth aspect, there is provided a method of making an active element, said active element comprising or consisting of: a ceramic matrix material; a CO₂ sorbent; and water, wherein at least some of the CO₂ sorbent is embedded within the matrix material, the method comprising:
combining at least one clay material, a pore former, a CO₂ sorbent or precursor thereof, and water to form a paste, shaping the paste to form a green article, and firing the green article to form the active element.

In a fifth aspect, there is provided a method of making an active element, said active element comprising or consisting of: a ceramic matrix material; a CO₂ sorbent; and water, wherein at least some of the CO₂ sorbent is embedded within the matrix material, the method comprising:
combining at least one clay material, a pore former, and water to form a paste, shaping the paste to form a green article, and firing the green article to form the active element, impregnating the active element with a CO₂ sorbent or precursor thereof. The CO₂ sorbent or precursor thereof may be in solution, e.g. partially or fully dissolved.

In a sixth aspect, there is provided a method of making an active element, said active element comprising or consisting of: a polymer matrix material; a CO₂ sorbent; and water, wherein at least some of the CO₂ sorbent is embedded within the matrix material, the method comprising:
forming a first mixture comprising a first monomer, a solvent, a first catalyst, water and optionally at least one additive;
forming a second mixture comprising a second monomer, a CO₂ sorbent or precursor thereof, a second catalyst;
combining (or reacting) said first and second mixtures.

The at least one additive may be silicon oil. The first and second catalyst may be selected, independently of each other, from an amine catalyst, a tin catalyst. On combining said first and second mixtures a polymer foam reaction may be initiated resulting in the formation of a polymer foam matrix. The first and second monomers may be selected, independently of each other and in any combination from anhydride (e.g. PMDA), isocyanate (e.g. poly [(phenyl isocyanate)-co-formaldehyde] which may be abbreviated to P-MDI). Other suitable examples of anhydride may be selected from one or more of oxidiphthalic anhydride (ODPA), biphenyltetracarboxylic dianhydride (BPDA), benzophenonetetracarboxylic dianhydride (BTDA), diphenylsulfonetetracarboxylic dianhydride (DSDA). A suitable isocyanate monomer is toluene diisocyanate (TDI).

In the fourth, fifth, and sixth aspects of the invention, there may be further combined a solid material (e.g. a hygroscopic, hydrophilic, or desiccant) which provides a source of water in the formed active element. A desiccant is generally considered to be a type of hygroscopic material. This solid material may be the source of water in the fourth, fifth and sixth aspects, and/or it may be an additional source of water. In the fourth and fifth aspects, said solid material may be combined with the paste. In the sixth aspect, said solid material may be combined in the first and/or second mixture. The solid material may be incorporated in solution or partial solution or in a dispersion or slurry. The solid material may be selected from one, or more, or any combination of aluminium oxide (e.g. Al₂O₃), zeolite, silicate, (e.g. silica gel), metal organic framework (MOF), clay, (e.g. kaolinite). The use of said solid material is also applicable to the first three aspects of the invention.

In the various methods of the invention, the CO₂ sorbent may be combined in an inactive form. The inactive element may be heated in order to convert the CO₂ sorbent into its active form. For example, the CO₂ sorbent may be added in the form of a bicarbonate and following heating be converted to a carbonate. For ease of reference, the CO₂ sorbent may be referred to as being in an active or inactive form. There may also be referred to herein a CO₂ sorbent precursor. For example, potassium bicarbonate may be described as a CO₂ sorbent precursor because it may be readily converted to potassium carbonate which is a CO₂ sorbent. Hence, any reference to a CO₂ sorbent in the various aspects and embodiments of the present invention may be replaced by the feature a CO₂ sorbent precursor.

In the various aspects of the invention, the active element may be formed into particles. For example, the active element may be crushed, ground, or milled and optionally sieved.

The CO₂ sorbent may also be referred to herein as a CO₂ reactive material. The function of the CO₂ reactive material or sorbent is to reduce the amount of CO₂ in the gas stream which flows through it. This may occur through adsorption, absorption or chemical reaction including any combination thereof.

In the various aspects of the invention, the gas may be air or it may be an exhaust gas, for example from a combustion engine or a gas generated in an industrial process.

There are numerous advantages associated with the present invention. For example, the air filters in accordance with the present invention provide one or more of economy of size, higher loading, improved efficiency, and are readily and efficiently regenerated for repeat use.

### BRIEF DESCRIPTION OF THE DRAWINGS

This and other aspects of the present invention will now be described in more detail, with reference to the appended drawings showing embodiments of the invention.

FIG. 1a shows a representation of the active element in accordance with the present invention, wherein the active element is in the form of a minilith comprising micro channels.

FIG. 1b shows a representation of the active element in accordance with the present invention, wherein the active element is in the form of a matrix material comprising a polymer.

FIG. 1c shows a representation of the active element in accordance with the present invention wherein the active element comprises a combination of the embodiments illustrated in FIGS. 1a and 1b in sandwich form.

FIGS. 2a-2c show a gas (e.g. air) filter in accordance with the present invention incorporating an active matrix as described in connection with FIGS. 1a-1c respectively.

FIG. 3a shows an extruded minilith made in accordance with Example 1 comprising a number of microchannels.

FIG. 3b shows an SEM (scanning electron micrograph) of a carbonate/bentonite/alumina minilith made in accordance with Example 1.

FIG. 3c shows an SEM of a carbonate/bentonite/alumina minilith made in accordance with Example 1 after leaving on a lab bench under ambient conditions for 24 hours.

FIG. 3d shows an SEM of the sample from FIG. 3c after testing with CO₂ and showing the formation of bicarbonate.

FIG. 3e shows an SEM of bicarbonate/bentonite/alumina (20%) extrudates made in accordance with Example 1 regenerated at 165° C. after testing with 4% CO₂ and 93% moisture at 32° C., 1 bar and 500 ml/min flow rate of CO₂ and shows the high surface area meso/macroporous structure (active form).

FIGS. 4a-4d show CO₂ breakthrough curves using samples from Examples 1-3 based on a flow rate of 1 l/min of CO₂.

FIG. 4a shows results (Cₜ/Cₒ plotted against time) for minilith extrudates for Example 1 using 4% CO₂.

FIG. 4b shows results (Cₜ/Cₒ plotted against time) for minilith extrudates for Example 1 using 0.5% CO₂.

FIG. 4c shows results (Cₜ/Cₒ plotted against time) for minilith extrudates for Example 2 using 4% CO₂.

FIG. 4d shows results (Cₜ/Cₒ plotted against time) for minilith extrudates for Example 3 using 4% CO₂.

FIGS. 5a-5d show SEM images in connection with Examples 4 and 5.

FIG. 5a shows an SEM image of bicarbonate foam made in accordance with Example 4.

FIG. 5b shows an SEM image of a foam made in accordance with Example 4 after regeneration to form the carbonate.

FIG. 5c shows an SEM image of carbonate matrix made in accordance with Example 5 and after testing with moisture and CO₂.

FIG. 5d shows an SEM image of carbonate matrix made in accordance with Example 5 following regeneration and after testing with moisture and CO₂.

FIGS. 6a-6(i) show SEM images in accordance with Example 5.

FIG. 6a shows K₂CO₃ derived from KHCO₃ powder by regenerating at 165° C. for 24 hours at ×100.

FIG. 6b shows K₂CO₃ derived from KHCO₃ powder by regenerating at 165° C. for 24 hours at ×3000.

FIG. 6c shows K₂CO₃ derived from KHCO₃ in a polyimide matrix after regeneration at 165° C. for 24 hours.

FIG. 6d shows pure KHCO₃ at ×100 (inactive form).

FIG. 6e shows pure KHCO₃ at ×3000 (inactive form).

FIG. 6f shows K₂CO₃ being converted into KHCO₃ in the polyimide foam after being exposed to CO₂ and moisture.

FIG. 6g shows bicarbonate powder with a particle size in the range of 7 to 45 μm which displays white specks on the smooth surface.

FIG. 6h shows a first regenerated structure, i.e. the bicarbonate has been heated and converted to the carbonate form for the first time. The active form (carbonate) displays what may be described as a “brain-like” (in appearance) texture of high surface area which allows for CO₂ and moisture to be readily trapped. Exposure to CO₂ and moisture results in the conversion of carbonate to bicarbonate with white specks as shown in FIG. 6g.

FIG. 6i shows a second regenerated structure, i.e. the bicarbonate has been heated and converted to the carbonate form for a second time. The active form (carbonate) displays what may be described as a “brain-like” texture of high surface area which allows for CO₂ and moisture to be readily trapped. Exposure to CO₂ and moisture results in the conversion of carbonate to bicarbonate with white specks.

FIGS. 7a-7c show the effect of temperature on adsorption breakthrough curves of two samples (in accordance with Example 4) of polyimide (PI)/alumina (40 wt %)/KHCO₃ (40 wt %) challenged with 4% vol CO₂ in air at 20° C., 32° C. and 45° C. in 4 hours.

FIG. 7a: 20-BC (active foam tested at 20° C.).

FIG. 7b: 32-BC (active foam tested at 32° C.).

FIG. 7c: 45-BC (active foam tested at 45° C.) compared with 45-BC+extrudate.

FIG. 7d illustrates the effect of the number of regenerating cycles on the reaction and removal of CO₂ and the observed stable bicarbonate/carbonate foam after six regeneration cycles (in accordance with Table 4, Example 5).

FIG. 7e illustrates the effect of operating temperature on the reaction and removal of CO₂ and the associated performance of the carbonate foam. The figure illustrates an increase in capacity and stable reaction conditions at a temperature of 45° C. (in accordance with Table 5, Example 5).

FIG. 8 shows a schematic diagram of the adsorption flow-breakthrough apparatus used to determine the sorption/reactive properties of the samples tested in accordance with the present invention.

### DETAILED DESCRIPTION OF THE INVENTION

Gas Filter

The gas filter may be in a form wherein it is suitable for filtering air or it may be in a form which is suitable for filtering other sources of gases or gas streams. For example, it may be used to filter exhaust gases such as those emitted by a combustion engine. Essentially, and regardless of the precise application, the gas filter comprises the same elements which are a gas inlet and a gas outlet. Any reference to “gas” herein is taken to also include a reference to “air” which is a type of gas. The gas (e.g. air) filters in accordance with the present invention are suitable for use in various environments or applications including in the health industry and the transport industry, for example in the airline and automotive industries. The air filters may be used in aircraft cabins or automobile cabins.

The gas filter may comprise a structure for housing the active element. The housing structure may typically comprise a gas inlet and a gas outlet and may also comprise a gas distributor such as a gas distributor plate which ensures the gas at the gas inlet is more evenly spread when it enters the gas filter and thus makes more efficient use of the active part of the gas filter. Housing structures are well known and typically comprise a means of attachment to the active part of the gas filter. The matrix material is effectively a filled matrix material and may be referred to herein as such. The filled matrix material may also be referred to herein more generally as the active element.

The active element also comprises water or moisture or a source of water or moisture. Typically, the water is embedded in the polymer matrix along with the CO₂ sorbent. Suitable sources of water include one or more hygroscopic, e.g. desiccant materials. The present inventors have found that aluminium oxide in particulate form (e.g. alpha Al₂O₃) is particularly useful as a source of water or moisture and may be readily embedded in the matrix material.

By way of example, the case may be considered wherein the CO₂ sorbent is an alkali metal carbonate such as potassium carbonate. The manner in which potassium carbonate removes CO₂ in the gas filter may be considered with reference to Equation 1 below (Eqn 1):

K₂CO₃+H₂O+CO₂↔2KHCO₃ Eqn 1

As indicated in Eqn 1, the reaction is reversible and provides a mechanism by which the gas filter may be regenerated. Potassium carbonate reacts with water and carbon dioxide to form potassium bicarbonate (KHCO₃) hence removing CO₂ from a gas stream such as air. By heating the potassium bicarbonate to a suitable temperature the reaction moves from right to left and potassium carbonate is formed, thus providing a gas filter which is ready for further use. Following heating, the structure or gas filter may be said to be regenerated, or recycled or in an active form.

The precise design of the gas filter may depend on a number of variables primarily with regard to achieving the desired levels of removal of CO₂, including air flow velocity, installation configuration, acceptable pressure drop and life requirements. The gas filters in accordance with the present invention seek to provide one or more of: minimum pressure drop; minimum weight; high collapse strength; improved energy savings; and long service life.

Matrix Material

The matrix material supports the CO₂ sorbent. At least some, or substantially all, or all of the CO₂ sorbent is embedded in the matrix material. As such, the matrix material may be referred to herein as a filled matrix material. Typically, the CO₂ sorbent is distributed throughout the matrix material and is embedded therein such that most of the sorbent is surrounded by matrix material. However, some of the sorbent may not be embedded and may be present on the surface of the matrix material. As such, the matrix material may be coated with the CO₂ sorbent, however it is a requirement that there is at least some CO₂ sorbent which is embedded in the matrix. Typically, the CO₂ sorbent is distributed in a random manner in the matrix material and is therefore not distributed homogeneously.

The matrix may be formed from a polymer or from a ceramic material.

The matrix material may be porous. As such, there may be present a number of pores or channels or voids in the matrix material. Some of the pores may be interconnected. The presence of the pores or channels provides a route through which the CO₂ may diffuse. The distance a CO₂ molecule has to travel through the matrix material before it is absorbed, adsorbed or reacts may be referred to herein as the diffusion path length. Preferably, the matrix material is mesoporous and/or macroporous. A mesoporous material is a material containing pores with diameters between 2 nm and 50 nm. A macroporous material is a material having pores larger than 50 nm in diameter. Hence it is possible for a material to exhibit a range of different types of porosity using classification. The dimensions of the pores may be measured using electron microscopy or nitrogen adsorption.

The present inventors have found that the dimensions of at least some, substantially all, or all of the pores in the matrix material may possess at least one or a combination of the following:
a) a pore diameter of about 200 μm to about 600 μm, for example about 200 μm to about 500 μm;
b) an average pore diameter of about 300 μm to about 400 μm, for example about 320 μm to about 350 μm;
c) a pore window diameter of about 300 μm to about 900 μm, for example about 400 μm to about 800 μm, for example about 500 μm to about 800 μm;
d) an average pore window diameter of about 500 μm to about 800 μm, for example about 600 μm to about 700 μm.

The dimensions above are particularly preferred in seeking to achieve a high CO₂ capacity for the matrix (or active element), which means that higher proportions of CO₂ may be removed from gas. In the above ranges, the pore diameter refers to the range of diameters for a given pore. The pore window diameter is the diameter of the pore at the opening to the pore. The various dimensions may be measured using electron microscopy, e.g. a scanning electron microscope.

The present inventors have also found that the CO₂ sorbent may concentrate at or along the surface of the pores which is advantageous. By surface of the pore or pores is taken to mean the surface of the pores (or channels or voids) in the matrix through which the CO₂ diffuses. If a given pore or channel is envisaged as a hollow pipe like structure, the surface thereof is the surface which is available inside the pipe and may therefore also be referred to as an inner surface. The concentration of CO₂ sorbent may be expressed per given area of the surface of the pores. The concentration of CO₂ sorbent may be greatest at or close to the inner surface(s) of the pores and/or at the pore window(s). For example, the concentration of CO₂ sorbent may be greatest at, or close to, the inner surface of the pores and/or at the pore window over a combined surface area of about 50 μm² and optionally measured to a depth of about 1 μm when measured from the edge of an inner surface in the direction of the body of the matrix.

The CO₂ sorbent (or precursor thereof) may also be concentrated at the surface or towards the surface of the matrix on which the CO₂ is first incident.

The matrix material may be present in amount of about 20 wt % to about 95 wt % based on the total weight of the active element. For example, the range may be up to about 60 wt %, or to about 50 wt %, or to about 40 wt %.

Polymer

When the matrix is formed from a polymer the resulting matrix material may be a foamed polymer or polymer sponge.

Polymer foams are used in a wide variety of applications such as packaging and insulation. Polymer foams are made up of a solid and gas phase mixed together to form a foam. The resulting foam has a polymer matrix with air bubbles and/or air tunnels incorporated in it which may be referred to as a closed cell or an open cell structure. The gas that is used in the foam is termed a blowing agent and may be chemical or physical in nature. Physical blowing agents are gases that do not react chemically with the foaming process and are therefore inert to the polymer forming the matrix. Chemical blowing agents are chemicals that take part in the reaction or decompose giving off chemicals in the process. The blowing agent may comprise or consist of any one of or any combination of nitrogen gas, carbon dioxide gas or an organic gas. A suitable organic gas may be chosen from C1-C6 alkane, wherein the alkane may be unsubstituted or substituted with fluorine and/or chlorine. The blowing agent may be formed in-situ when the polymer matrix is being synthesised.

The polymer foam may comprise a polymer suitable for use in forming polymer foams. For example, the polymer foam may comprise one or more, or any combination of polyurethane (PU), poly(vinylpyrrolidone) (PVP), polyimide (PI), polymers of intrinsic microporosity (PIMs), polyvinylidene difluoride (PVDF), polyethersulfone (PES), cellulose or bio-degradable polymers such as polylactic acid (PLA) and poly(lactic-co-glycolic acid) (PLGA). Polyimide is particularly preferred in the present invention. Polyimide may be the only polymer present in the matrix or the polyimide may be combined with other polymers. The polymer or polymer foam may be prepared using appropriate monomer(s). For example, monomer(s) may be selected, independently of each other and in any combination from anhydride (e.g. PMDA), isocyanate e.g. poly [(phenyl isocyanate)-co-formaldehyde], (P-MDI) which may be used as a chain extender or cross-linker, or toluene diisocyanate (TDI). Other suitable examples of anhydride may be selected from one or more of oxidiphthalic anhydride (ODPA), biphenyltetracarboxylic dianhydride (BPDA), benzophenonetetracarboxylic dianhydride (BTDA), diphenylsulfonetetracarboxylic dianhydride (DSDA).

The polymer matrix may be porous, for example mesoporous and/or macroporous.

Ceramic

The ceramic matrix is formed from a ceramic forming composition or ceramic precursor composition. Typically, the ceramic precursor composition is formed in a green state and is then fired to form the final ceramic matrix material. A green body is an object whose main constituent is weakly bound clay material usually in the form of a bonded powder or plates before it has been sintered or fired. The firing conditions are such that the green form is converted to the final ceramic form. Firing may take place in one or a number of stages. For example, the green body or article may be heated by slowly ramping up the temperature to an initial temperature, for example about 100° C. to about 120° C. over a period of up to about 20 hours, more specifically about 110° C. over a period of about 18 hours followed by a shorter ramp over about 8 hours to about 12 hours, for example about 10 hours to a temperature of about 800° C. to about 1100° C.

The ceramic matrix may comprise, consist of, or consist essentially of a clay.

The ceramic matrix may comprise, consist of, or consist essentially of kaolinite, montmorillonite-smectite, ilite, chlorite clay, clinoptalite, palygorskite, attapulgite, bentonite. One, or more than one, or any combination of these materials may be present in the ceramic matrix.

Ceramic materials are commonly provided with a natural porosity determined by the composition and the grain structure of the raw materials, and by the driving out of the water during drying and firing. Various ceramic products with higher porosity levels have been developed. The incorporation of pores is commonly obtained by means of so-called porogens, i.e., pore forming materials such as graphite, polymer beads, fine powders, or fibres, which burn, evaporate or gasify upon heating without leaving residues. Suitable polymers include poly(vinylpyrrolidone) (PVP). Porogens are commonly premixed with the ceramic precursors and volatilize during the firing step, thus leaving pores in the ceramic body which correspond to the space originally occupied by the porogen particles.

As such, also present in the ceramic precursor composition (or green body) may be at least one pore former or porogen. During the firing process the porogen volatizes to leave a pore or network of pores. At least some of the pores may be interconnected. Examples of suitable pore formers for use in connection with the present invention include carbon, e.g. graphite, activated carbon, e.g. Nuchar® activated carbon SA-20, cornflower, wheat flour, wax, e.g. licowax.

Prior to firing to form the ceramic structure the ceramic precursor composition may be extruded to form an extrudate.

The ceramic matrix may be a monolithic or a minilithic structure. The monolithic and/or minilithic structures are typically formed as extrudates. A minilithic structure is of similar structure to a monolithic structure and is characterised by comprising channels which are of micro dimensions. This means that the channels possess a diameter less than 1 mm. The dimensions of the channels may be measured using electron microscopy.

The gas filter may comprise a number of the ceramic matrix active elements. The ceramic matrix may be ground or milled. The ceramic matrix may be in particulate form.

CO₂ Sorbent

The CO₂ sorbent may adsorb and/or absorb the carbon dioxide and/or react chemically with the carbon dioxide. In the following discussion, reference may focus on the use of alkali metal carbonates, (particularly potassium carbonate), however other CO₂ sorbents or reactants are suitable for use in connection with the present invention. Other examples include sodium carbonate (Na₂CO₃) and/or lithium carbonate (Li₂CO₃).

The manner in which a sorbent such as potassium carbonate removes CO₂ in the gas filter may be considered with reference to Equation 1 below (Eqn 1):

K₂CO₃+H₂O+CO₂↔2KHCO₃ Eqn 1

The potassium carbonate reacts in the presence of water with the carbon dioxide to form a bicarbonate thus removing or chemisorbing carbon dioxide from the incident gas stream and reacting with it.

Typically, the reaction takes place in the temperature range of about 30° C. to about 50° C., for example about 32° C. to about 45° C., for example at about 40° C.

As indicated in Eqn 1, the reaction is reversible and the equilibrium may be shifted to the left and potassium carbonate generated or regenerated from the potassium bicarbonate so that the gas filter can be re-used over a period of time. Regeneration is conducted by the application of heat and a suitable temperature range is about 100° C. to about 180° C., for example about 100° C. to about 165° C.

The present inventors have found that it may be advantageous for the case where carbonate materials are used, to first load the corresponding bicarbonate to form the filled matrix material and to then (re)generate the bicarbonate material by the application of heat to form active carbonate. The bicarbonate may be referred to herein as a precursor CO₂ sorbent or precursor CO₂ reactant. The bicarbonate may be present in particulate form. For example, the particle size of the bicarbonate may be in the range of about 1 μm to about 50 μm, or about 5 μm to about 50 μm, or about 7 μm to about 50 μm, or about 1 μm to about 10 μm, or about 5 μm to about 50 μm, or about 7 μm to about 45 μm.

For reasons that will be clear, it may be that the matrix material, having been exposed to carbon dioxide, comprises carbonate and bicarbonate. This may be because only a portion of the carbonate may have been exposed to CO₂ and converted to bicarbonate, or only a portion of the bicarbonate has been regenerated, e.g., by the application of heat, to form the corresponding carbonate. Alternatively, it may be that the CO₂ sorbent or reactant is (substantially) 100 wt % carbonate or bicarbonate, or at least about 98 wt % carbonate or bicarbonate.

The present inventors have found that the more number of times the bicarbonate is regenerated to form carbonate, the more effective the gas filter becomes at removing CO₂. The number of times the bicarbonate is heated to form carbonate may be referred to herein as the number of cycles. Advantageously, the gas filter in accordance with the present invention is capable of being recycled many times, for example up to ten times or less than ten times. When the gas filter (or active material) is recycled, the resulting structure increases in surface area. Advantageously, this provides a longer so called path length along which the CO₂ can travel, and increases the likelihood that it will interact with the sorbent material, (and/or water).

For a given active element, the diffusion path length may be in the range of about 200 nm to about 4000 nm, for example about 300 nm to about 3500 nm, or about 500 nm to about 3000 nm, or about 700 nm to about 2800 nm. The path length may increase if the number of cycles is increased for a given structure.

The conversion or recycling of bicarbonate to carbonate may take place in a temperature range of about 100° C. to about 170° C., for example about 100° C. to about 165° C., or about 150° C. to about 165° C. or to about 170° C.

The CO₂ sorbent may be present in an amount of about 5 wt % to about 80 wt %, for example about 10 wt % to about 70 wt %, or to about 15 wt %, or to about 20 wt %, or to about 30 wt %, or to about 40 wt %, based on the total weight of the active element.

Water

Water may be introduced via one or more of a number of ways. The present inventors have found that it is advantageous if a source of water can be incorporated in the (main body of the) matrix material so that the water is, in effect, embedded therein. The water may be provided by a further solid material. The water may be provided by a hygroscopic material or a desiccant material. The hygroscopic material or desiccant material may be solid.

A desiccant is typically described as a hygroscopic substance which can be used as a drying agent. A well-known example of a desiccant is silica gel which is often used to keep packaged goods dry by reducing the amount of moisture or water vapour present. When used in connection with the present invention, the desiccant provides a source of, (or stores), water for the reaction outlined in Eqn 1. By functioning as a source of water or moisture, the desiccant effectively facilitates the sorption or removal of carbon dioxide and may facilitate a reaction in solution. The desiccant is not acting as a typical desiccant when in-situ given that it is providing water or moisture for a reaction. Hence, for the purposes of the present invention, the desiccant may be described as a desiccant (in so far as it performs as a desiccant) at a temperature of about 20-25° C., a pressure of about 101 kPa, and at a humidity of about 40 to 50% and when not comprised in the active element or matrix material or in combination with another material. However, when used in connection with the present invention and present in the matrix material it acts as a source of water in order to assist with the adsorption, absorption, and/or reaction with CO₂.

Desiccant materials are generally well known to the skilled person. For use in the present invention particulate alumina is preferred. Other examples of suitable desiccants include zeolite, silicate, for example silica gel, metal organic frameworks (MOFs), or clay minerals. The alumina may be in the form of alpha alumina (Al₂O₃).

The desiccant is typically provided in particulate form. For example, the aluminium oxide may be provided with a particle size distribution of about 0.5 μm to about 100 μm.

The desiccant or water source may be located close to the sorbent. For example, the desiccant or water source may be in direct contact with the sorbent. Some of the desiccant or water source may be within a distance of about 0.5 μm to about 40 μm of the nearest sorbent. At least 20 wt % of the desiccant or water source may be within a range of about 0.2 μm to about 20 μm of the nearest sorbent.

As mentioned, there are numerous ways in which the water may be introduced. For example, the active element may be exposed to a humidifier (humidified air) so that water vapour or moisture is taken up and stored in the matrix material.

The water may be introduced either by one of the methods mentioned herein or any combination thereof.

The water may be present in an amount of about 5 wt % to about 40 wt % based on the total weight of the active element. For example, up to about 30 wt %, or to about 20 wt %.

The additional solid, or hygroscopic material, or desiccant may be present in an amount of about 20 wt % up to about 60 wt % based on the total weight of the active element. For example, up to about 50 wt % or to about 40 wt %, or to about 30 wt %.

Operation of the Gas Filter

The temperature at which the gas filter is operated may be referred to herein as the operating or reaction temperature, “reaction” indicating the reaction between the CO₂ and CO₂ sorbent (and water). The operating temperature may be up to about 60° C. or up to about 50° C., for example about 10° C. to about 60° C., or about 20° C. to about 60° C., or about 30° C. to about 60° C. An operating temperature of about 40° C. to about 45° C. is preferred.

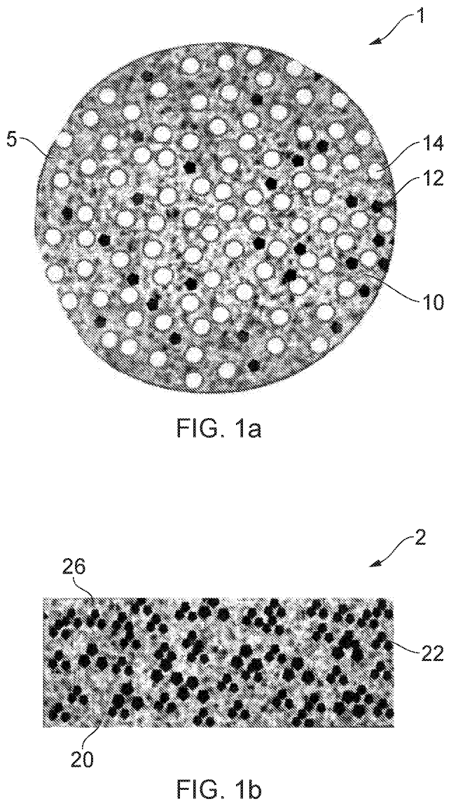

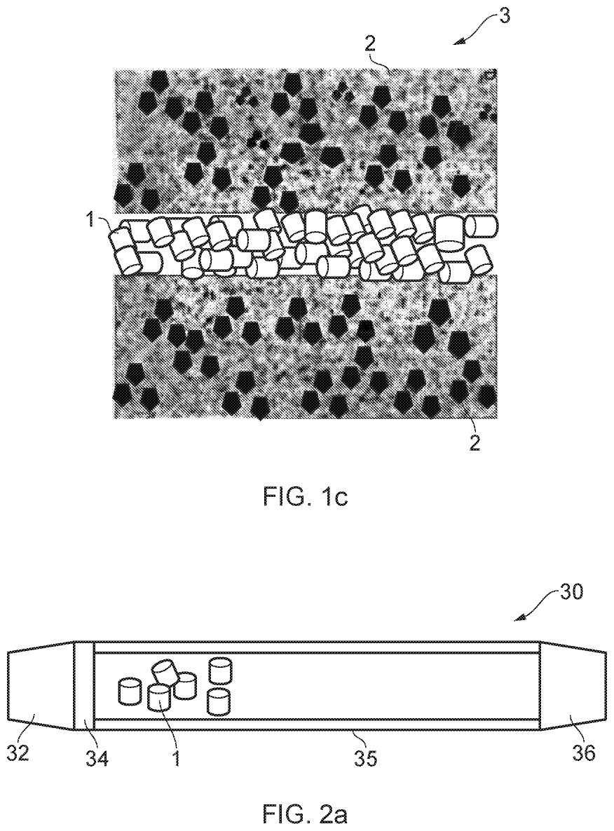

FIG. 1a is a representation of an active element indicated generally at (1), comprising a matrix material (5) in this case a ceramic clay within which is embedded or encapsulated a CO₂ sorbent or reactant (10) such as potassium carbonate and a source of water (12), in this case alumina particles. Also shown are a number of microchannels (14) which are open channels or voids in the structure. The CO₂ sorbent or reactant may be in the form of a precursor thereof, for example a bicarbonate such as potassium bicarbonate. The bicarbonate may be converted to the active version which removes the CO₂, for example by the application of heat.

FIG. 1b is a representation of an active element indicated generally at (2), comprising a matrix material (20) in this case a polymer such as polyimide within which is embedded or encapsulated a CO₂ sorbent or reactant (22) such as potassium carbonate and a source of water (26), in this case alumina particles. The CO₂ sorbent or reactant may be in the form of a precursor thereof, for example a bicarbonate such as potassium bicarbonate. The bicarbonate may be converted to the active version which removes the CO₂, for example by the application of heat.

FIG. 1c is a representation of an active element indicated generally at (3), comprising a combination of the active matrices described in accordance with FIGS. 1a and 1b. FIG. 1c shows a number of the active elements (1) sandwiched between active elements (2).

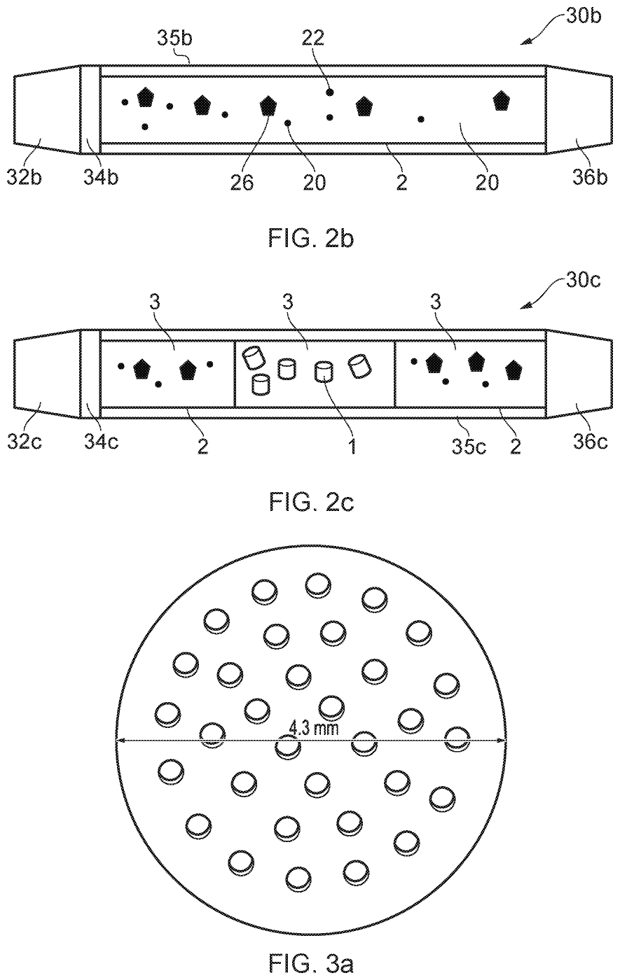

FIGS. 2a-2c show the embodiments described in FIGS. 1a-1c, referred to as active elements, incorporated into a gas (e.g. air) filter.

In FIG. 2a, the active element (1) is shown located in a filter housing (35). The air filter, indicated generally by (30), comprises an air inlet (32) and optionally an air distributor plate (34). Air enters the air filter at the inlet (32) and if present passes through the air distributor plate (34) so that the air is evenly spread through the active element (1) as it passes through. After the air passes through the active element (1) it exits the air filter through an air outlet (36). The air inlet and outlet may be chosen from an appropriate shape, independently of each other, for example it (or they) may be circular or square or rectangular in cross section.

In FIG. 2b, the active element (2) is shown located in a filter housing (35b). The air filter, indicated generally by (30b), comprises an air inlet (32b) and optionally an air distributor plate (34b). Air enters the air filter at the inlet (32b) and if present passes through the air distributor plate (34b) so that the air is evenly spread through the active element (2) as it passes through. After the air passes through the active element (2) it exits the air filter through an air outlet (36b). The air inlet and outlet may be chosen from an appropriate shape, independently of each other, for example it (or they) may be circular or square or rectangular in cross section.

In FIG. 2c, the active element (3) is shown located in a filter housing (35c). The air filter, indicated generally by (30c), comprises an air inlet (32c) and optionally an air distributor plate (34c). Air enters the air filter at the inlet (32c) and if present passes through the air distributor plate (34c) so that the air is evenly spread through the active element (3) as it passes through. After the air passes through the active element (3) it exits the air filter through an air outlet (36c). The air inlet and outlet may be chosen from an appropriate shape, independently of each other, for example it (or they) may be circular or square or rectangular in cross section.

### EXAMPLES

The invention will now be described by way of example only and without limitation, with reference to the following Examples.

### Examples 1-3: Ceramic Matrix Comprising Carbonate and Alumina

### Example 1

A paste formulation was prepared by mixing alpha alumina powder, clay, and pore former. Water was added to form the paste, followed by the addition of potassium bicarbonate (20-80 wt % based on the total weight of binder and desiccant). The alumina was an alpha alumina powder comprising a 50:50 by weight mixture of particles <1 μm and 20-50 μm in size. The clays tested were clinoptalite, palygorskite, attapulgite, and bentonite. The pore formers tested were Nuchar carbon SA-20, PVP, corn flour, or licowax. The pore former was present in an amount of 3-10 wt % based on the total dry weight of mixture. The paste was mixed thoroughly and left to rest wrapped in a towel for a period of 1-2 days before being extruded into micro channeled miniliths with diameters ranging from about 3 mm to about 1 cm. The unfired, or green, structures were then fired by slowly ramping up the temperature to 110° C. over a period of 18 hours followed by a shorter ramp over 10 hours to a temperature of 800-1100° C. The samples were cooled and adsorption columns packed with the samples for breakthrough testing or crushed and sieved to obtain particles of less than 1.4 mm in diameter.

### Example 2

A mixture was prepared by combining 40 g of bentonite, 360 g of alumina (same sample as used in Example 1), 12 g of Nuchar carbon and 252 g of water. The paste was mixed thoroughly and left to rest for two days. The paste was extruded through a 4.4 mm die and calcination was carried out at 1100° C. resulting in rods of approximately 3.8 mm diameter. The extruded rods were dried at room temperature and fired in a furnace at 1100° C. for 10 hours in an atmosphere of air. The porous bentonite-alumina matrix was then impregnated with a solution of 250 g of potassium bicarbonate (KHCO₃) in 400 ml of water by mixing in a rotary evaporator at 90° C. The impregnated porous rods were subsequently heated to 165° C. for 2 days. CO₂ breakthrough tests were performed to assess the CO₂ removal capacity of the packed bed of porous bentonite-alumina matrix rods impregnated with 26.7 wt % of KHCO₃ which prior to the testing was converted to K₂CO₃.

### Example 3

In this example, a clay loaded with alumina particles possessing microchannels was impregnated with an aqueous solution of potassium bicarbonate. The microchannel structure was produced by mixing alumina (70 wt %), potassium bicarbonate (20 wt %) and bentonite (10 wt %) with water (1 part of water for 1.6 parts of solid). The alumina was the same as that used in Examples 1 and 2. 3 wt % of the pore former Nuchar® carbon SA-20 was incorporated into the solid mixture. A paste was formed and left to rest for 1-2 days before extrusion, followed by drying and firing at 700° C. to 1100° C. The firing temperature was carefully selected in order to provide a strong structure and to avoid a phase shift of the alumina from the alpha phase into the gamma phase. The structures were cut, crushed and sieved. 250 g of potassium bicarbonate was dissolved in 400 ml of water at 60° C. to make a saturated solution. The particulate material was dried overnight in a furnace at 165° C. to ensure a clean surface, including to ensure no water was adsorbed. The particles were placed into a glass tube suitable for fitting into a tubular furnace. The glass tube containing the porous particles, which were fully immersed in the bicarbonate solution, was placed in a tubular furnace and connected to a rotary evaporator. The additional bicarbonate incorporation was performed at 100° C. and under low vacuum for 1 hour and 30 minutes. The temperature was increased to 220° C. for 40 minutes to evaporate some of the water in the solution. The porous particles were then removed from the remaining solution and dried and calcined in an oven at 165° C. for at least 48 hours to ensure full conversion of the bicarbonate into carbonate.

Regeneration

After a number of CO₂ sorbent experiments had been run, the structures were regenerated by heating in order to convert the bicarbonate back to the corresponding carbonate. The samples were placed in a vacuum oven at 165° C. for at least 6 hours, 12 hours or 24 hours. Regeneration may also be carried out more generally in a temperature range of about 120° C. to 165° C.

Results

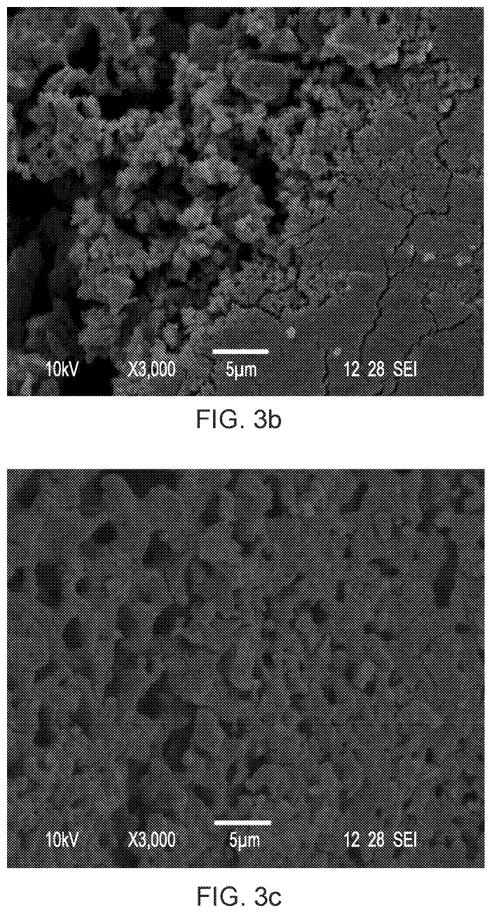

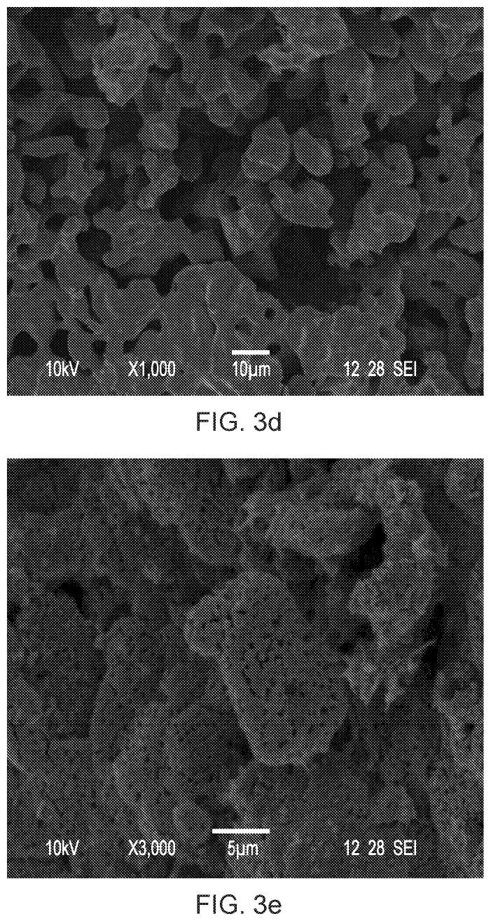

The following results were obtained in connection with Example 1. FIG. 3 (a) shows an extruded minilith comprising potassium bicarbonate and prepared in accordance with Example 1. FIG. 3 (b) is an SEM of a potassium carbonate/bentonite/alumina minilith made in accordance with Example 1 and shows the presence of carbonate in the extrudate. FIG. 3 (c) is an SEM (×3000) of carbonate/bentonite and alumina. FIG. 3 (d) is an SEM of bicarbonate, after testing with 4% CO₂ and 93.0% moisture (RH) at 32° C., 1 bar and 500 mL/min. FIG. 3 (e) is an SEM of carbonate/bentonite/alumina (20%) extrudates regenerated at 165° C. after testing with 4% CO₂ and 93% moisture at 32° C., 1 bar and a flow rate of 500 mL/min. The SEM shows changes in the structure due to switching back (i.e. regenerating) to carbonate from bicarbonate.

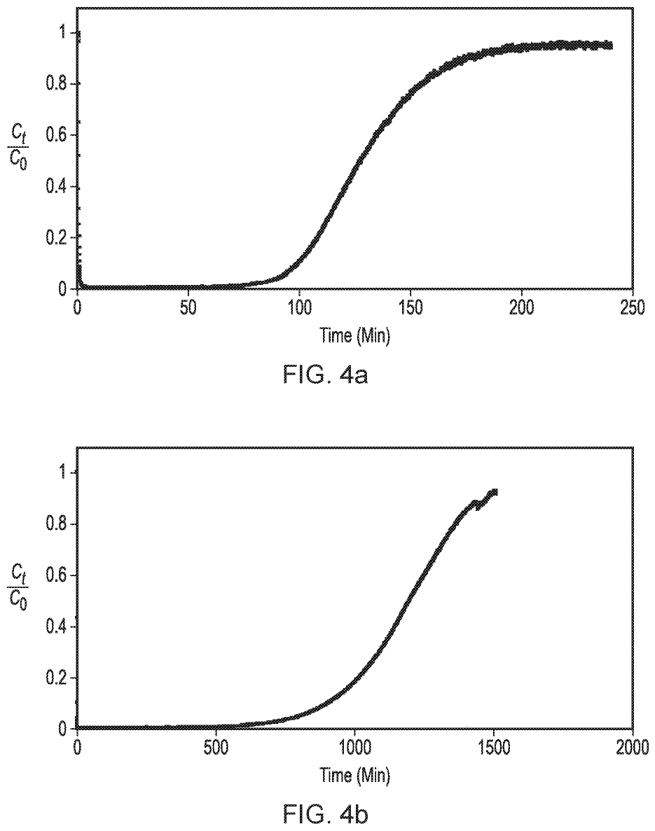

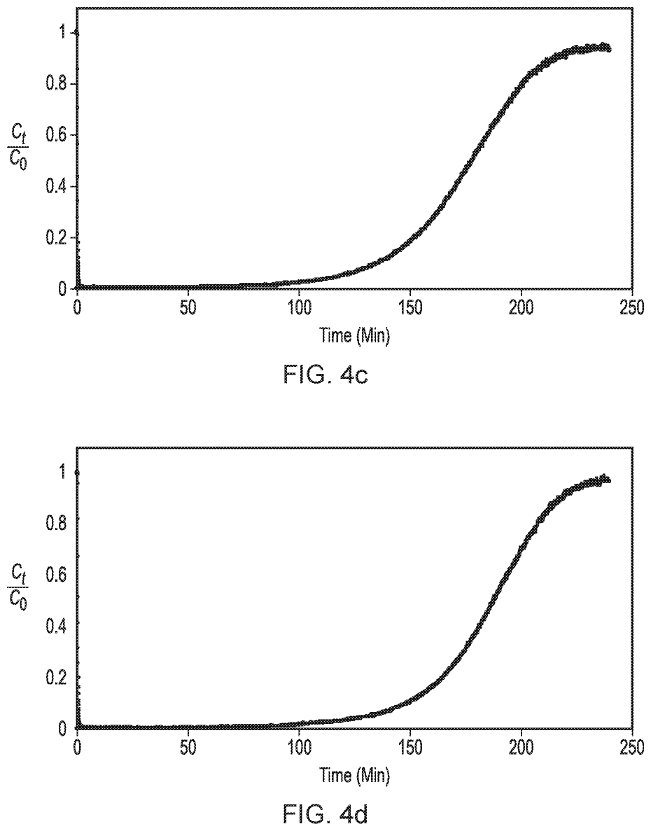

FIGS. 4a-4d show graphs obtained for CO₂ breakthrough studies for Examples 1-3. Breakthrough studies were performed using a flow rate of 1 l/min and CO₂ concentrations of 4% or 0.5%. FIG. 4(a) shows results obtained for minilith extrudates for Example 1 using 4% CO₂. FIG. 4(b) shows results obtained for minilith extrudates for Example 1 using 0.5% CO₂ challenge. FIG. 4(c) shows results for extrudates for Example 2 and 4% CO₂ challenge. FIG. 4(d) shows results for extrudates for Example 3 using 4% CO₂.

The loading details are summarised in Table 1 which shows the equilibrium loading of CO₂ on bicarbonate miniliths/extrudates challenged with 4 vol % and 0.5 vol % CO₂ in air at 32° C.

TABLE 1

| | | q_{eq} (wt %) CO₂ |
|---|---|---|
| Example | Sample/challenge | Loading |
| 1 | FIG. 3 (a)-4% vol. CO₂ | 24.76 |
| 1 | FIG. 3 (b)-0.5% vol. CO₂ | 26.10 |
| 2 | FIG. 3 (c)-4% vol. CO₂ | 30.48 |
| 3 | FIG. 3 (d)-4% vol. CO₂ | 32.85 |

q_{eq} (wt %) CO₂ loading is the equilibrium loading of CO₂ on the minilith.

### Examples 4-5: Polymer Matrix Comprising Polymer, Alumina, and Bicarbonate (Converted to Carbonate)

### Example 4

In Example 4, a highly porous polymer matrix was prepared embedded with alumina and potassium bicarbonate. A first mixture was prepared by mixing pyromellitic dianhydride (PMDA) and N-Methylpyrrolidone (NMP) in a ratio of 1:7 by weight with an amine catalyst (˜50 μl), distilled water (2 ml) and silicon oil (1.65 g) using a homogeniser at 6500 rpm for 30 seconds. A second mixture was prepared by mixing alumina powder (10 g of <10 μm and 10 g of 20-50 μm), potassium bicarbonate powder (20 g) and a tin catalyst (˜25 μl). The second mixture was stirred using a homogeniser at 6500 rpm for 30 seconds. This second mixture was then added to 5 g of isocyanate and mixed in the homogeniser at 6500 rpm for 5 seconds.

During the final mixing step, the polymer foaming process started which involved the one step method of encapsulating carbonate powder and binding the alumina powder within the structure. The blowing and polymerization reactions took place simultaneously and created mesoporosity and macroporosity in the matrix. The isocyanate and water reacted during the blowing reaction to produce CO₂ and a polymer, the polymer acting in effect as a binder in the matrix. Alumina particles aided the creation of a high surface area porous structure as well as acting as a source of moisture which assisted in the removal of CO₂. The homogenization produced many microbubbles which served as nucleation sites for CO₂. As more CO₂ was produced by the reaction, the expanding air bubbles caused the matrix to rise. The amine catalyst limited the rate of the blowing reaction to produce a more consistent and controllable rise.

The highly porous matrix created allowed for the effective encapsulation of KHCO₃ which produced a high reactive surface area and with minimal mass transfer resistance for the reaction. The matrix was allowed to rest on a bench surface so that any residual solvents were removed. Slow evaporation of any solvent present reduced the shrinkage of the structure.

Higher loading of bicarbonate and a strong mechanically stable structure were achieved by soaking the polymer matrix in a saturated KHCO₃ solution (100 g KHCO₃ in 500 ml distilled water), followed by drying in an oven at 100° C. until no change in the matrix weight was recorded. The samples were converted from bicarbonate to carbonate in order to test for their ability to remove CO₂.

The samples prepared in accordance with Example 4 were tested for their ability to remove CO₂ from air at a range of temperatures (operating temperature). The samples tested are set out in accordance with Table 2. “BC” is short for bicarbonate.

TABLE 2
Polyimide (PI)/Alumina/KHCO₃ samples

| Regeneration | Operating | Alumina | KHCO₃ | |
|---|---|---|---|---|
| Temperature | Temperature | Content | Content | Sample |
| (° C.) | (° C.) | (wt %) | (wt %) | Name |
| 165 | 20 | 40 wt % | 40 wt % | 20-BC, H10S1 |
| | | | | 20-BC, H10S2 |
| | 32 | | | 32-BC, H1S1 |
| | | | | 32-BC, H2S1 |
| | | | | 32-BC, H4S1 |
| | | | | 32-BC, H6S1 |
| | | | | 32-BC, H1S2 |
| | | | | 32-BC, H2S2 |
| | | | | 32-BC, H4S2 |
| | | | | 32-BC, H6S2 |
| | 45 | | | 45-BC, H7S1 |
| | | | | 45-BC, H8S1 |
| | | | | 45-BC H7S2 |
| | | | | 45-BC H8S2 |

The terms “20”, “32”, and “45” indicate the operating temperature in ° C., “H” indicates the number of heat cycles and “S” indicates a different foam sample but with the same formulation.

### Example 5

A number of filled polymer foams were prepared comprising polyimide, alumina and potassium bicarbonate. The amount of filled polyimide/alumina was 60 wt % and the amount of potassium bicarbonate was 40 wt % based on the total weight of the filled polyimide.

A first mixture was prepared by mixing PMDA:NMP (1:8 by wt), distilled water (2 mL), amine catalyst (˜50 μL), silicon oil (1.65 g) using a homogeniser at 6500 rpm for 30 seconds.

Alumina powder (<1 μm) (10 g), alumina powder (20-50 μm) (10 g), potassium bicarbonate (KHCO₃) powder (20 g) and tin catalyst (˜25 μL) were added to the mixture and stirred using a homogeniser at 6500 rpm for 30 seconds to generate a second mixture. The second mixture was then added to 5 g of isocyanate and mixed using the homogenizer at 6500 rpm for 5 seconds.

During the final mixing step, the foaming of the polyimide began which involves the ‘blowing’ and polymerization reactions taking place simultaneously. During the blowing reaction, isocyanate reacts with the distilled water to produce an intermediate product carbamic acid which breaks down to produce CO₂ and a primary amine. The generated CO₂ creates pores in the foam.

Small air bubbles that were created during mixing served as nucleation sites for the CO₂. The CO₂ diffuses into the small air bubbles and as more CO₂ is generated, the bubbles expand and the foam starts to rise. The amine catalyst controls the reaction between the isocyanate group and water. At the same time, in the polymerization reaction, the primary amine reacts with PMDA to produce an amic-acid which subsequently imidizes to produce an imide whilst regenerating water at the same time. The presence of water during the foaming process is critical to the reaction.

During polymerization, gas-filled cells with thin walls are formed. This polymerization reaction is catalysed by the tin catalyst. The foaming process takes approximately 10-15 seconds for the mixture to rise and polymerize which is cost effective when compared with other known methods.

The polymerized KHCO₃ containing foam was then soaked in a bath saturated with KHCO₃ (100 g KHCO₃ in 500 mL distilled water), to avoid leaching of bicarbonate from the sponge) and to allow phase inversion of residual polymer. Said device was dried in an oven at 100° C. till no change in foam weight was observed. The regeneration of these carbonate sponges was possible at 80-165° C.

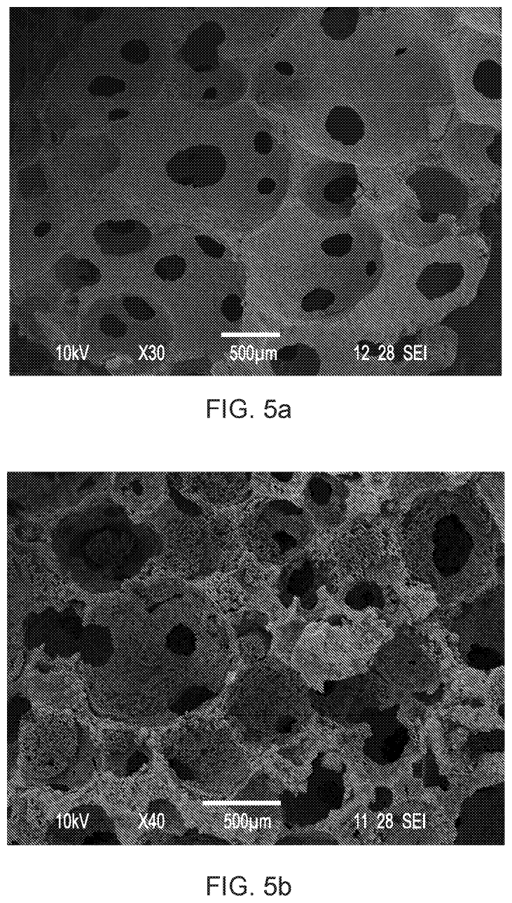

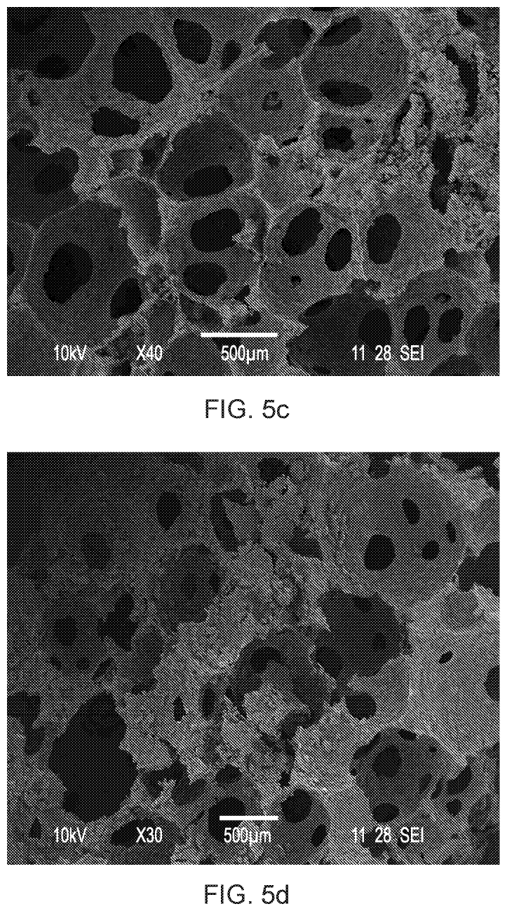

FIGS. 5 (a)-5 (d) show SEM foam analysis for samples made in accordance with Examples 4 and 5.

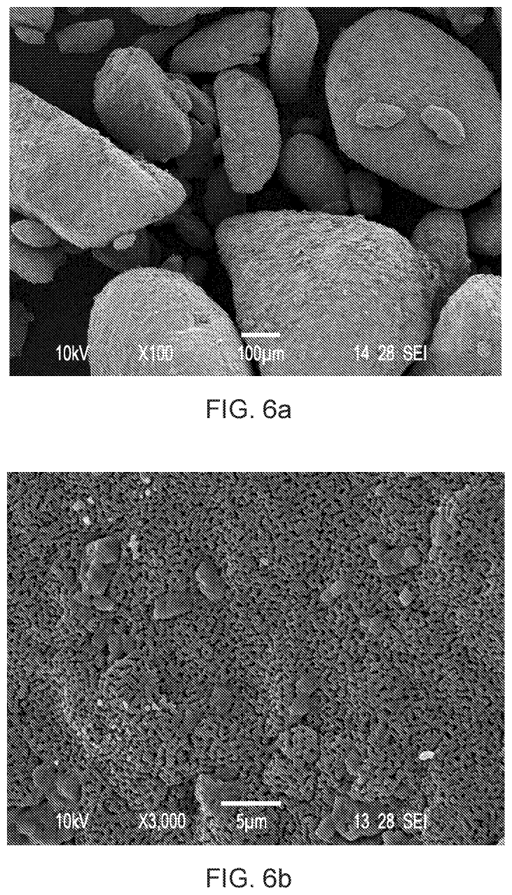

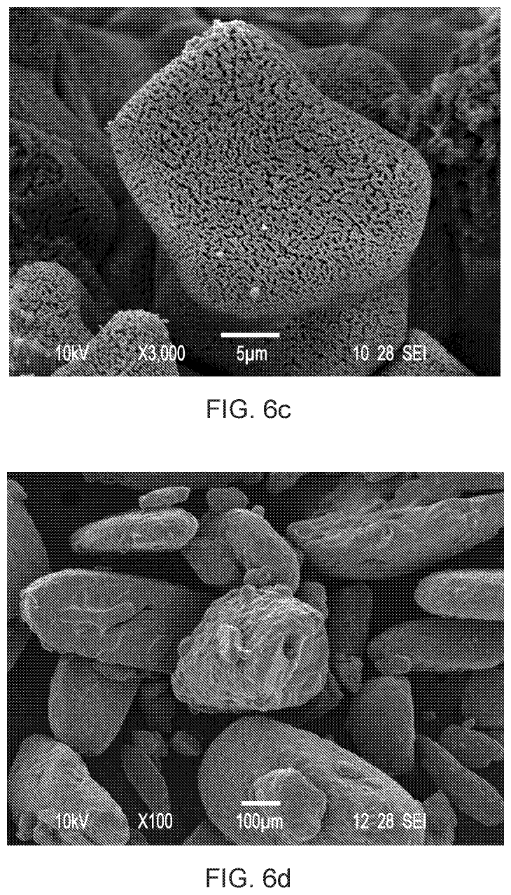

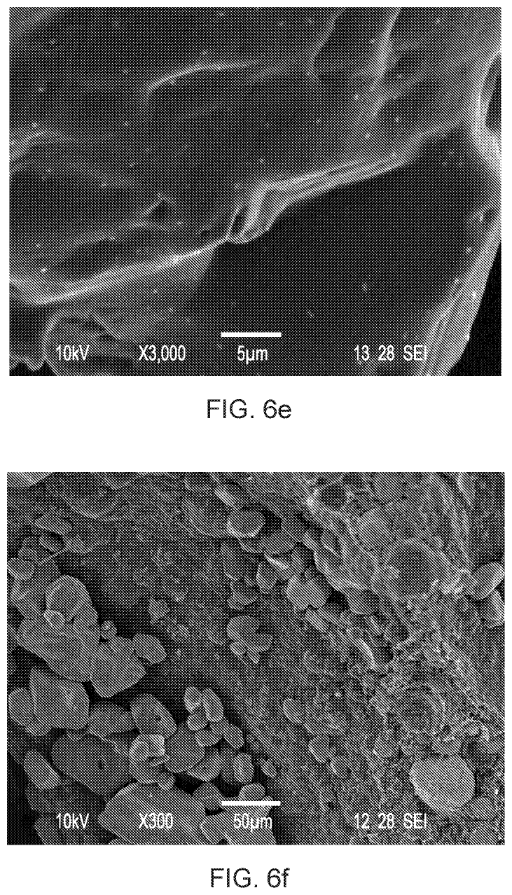

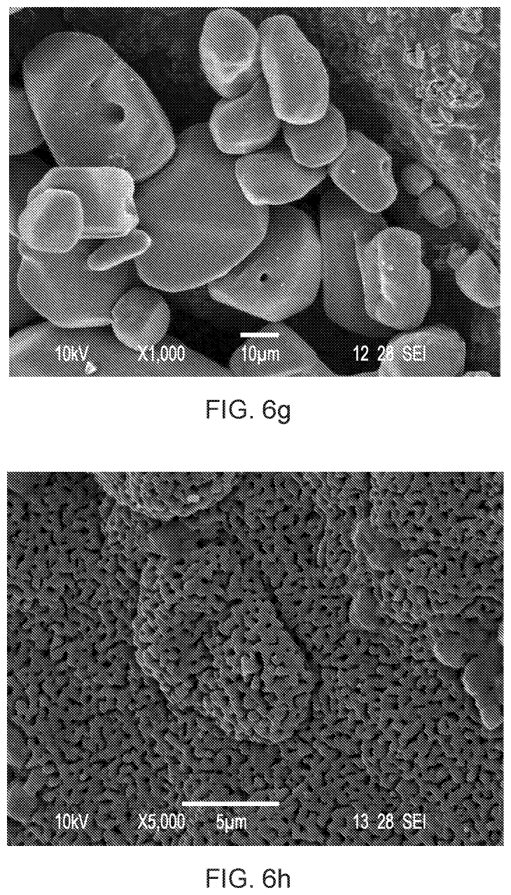

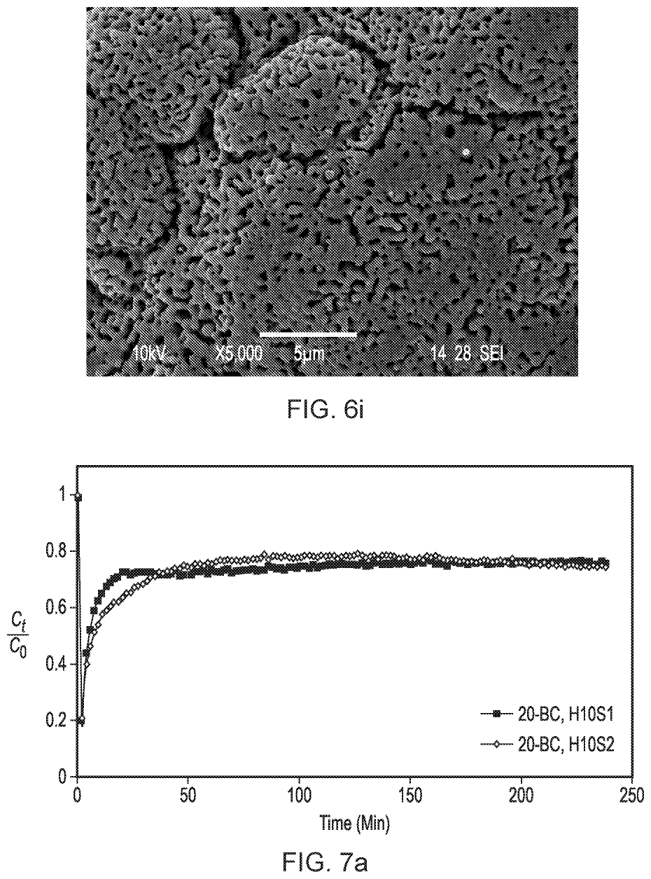

FIGS. 6 (a)-6 (i) show SEM analysis for samples made in accordance with Example 5.

Samples prepared in accordance with Example 4 were tested for their ability to remove CO₂ from air at a range of temperatures (operating temperature). The samples tested are set out in accordance with Table 2 above.

The results indicated that the effect of regenerating (i.e. cycling) the samples resulted in changes (increases) in the diffusion path length and in the pore sizes. These changes are set out below. These changes increased with the number of regeneration cycles. Increases in the diffusion path length and/or pore size meant that the amount of CO₂ (and moisture) removed from the incident gas was increased.

TABLE 2.1
Diffusion path length (nm)

| | |
|---|---|
| 1^{st} regeneration | 337.8-1283.8 |
| 2^{nd} regeneration | 743.2-2770.3 |

TABLE 2.2
Preferred pore sizes to achieve high CO₂ capacity

| Pore | Average pore | Pore window | Average pore |
|---|---|---|---|
| diameter | diameter | diameter | window |
| (μm) | (μm) | (μm) | diameter (μm) |
| 240.7-481.5 | 335.2 | 500-777.8 | 687.0 |

Table 3 shows the average equilibrium loading of a matrix of polyimide filled with alumina (40 wt %) and potassium bicarbonate (40 wt %) challenged with 4% vol of CO₂ in air at 20° C. in four hours after ten regeneration or heat cycles. In Table 3, “20” indicates the operating temperature (° C.) and “H” indicates the number of heat cycles.

TABLE 3

| Sample | ${q}_{eq} ( \frac{g {CO}_{2}}{g {K}_{2} {CO}_{3}} )$ |
|---|---|
| 20-BC, H10 | 0.085 ± 0.01 |

Table 4 shows the average equilibrium loading of a matrix of polyimide filled with alumina (40 wt %) and potassium bicarbonate (40 wt %) challenged with 4% vol of CO₂ in air at 32° C. in four hours after six heat cycles. In Table 4, “32” indicates the operating temperature (° C.) and “H” indicates the number of heat cycles.

TABLE 4

| Sample | ${q}_{eq} ( \frac{g {CO}_{2}}{g {K}_{2} {CO}_{3}} )$ |
|---|---|
| 32-BC, H1 | 0.067 ± 0.0053 (6.7% wt loading) |
| 32-BC, H2 | 0.086 ± 0.0016 (8.6% wt loading) |
| 32-BC, H4 | 0.13 ± 0.011 (13% wt loading |
| 32-BC, H6 | 0.15 ± 0.0035 (15% wt loading) |

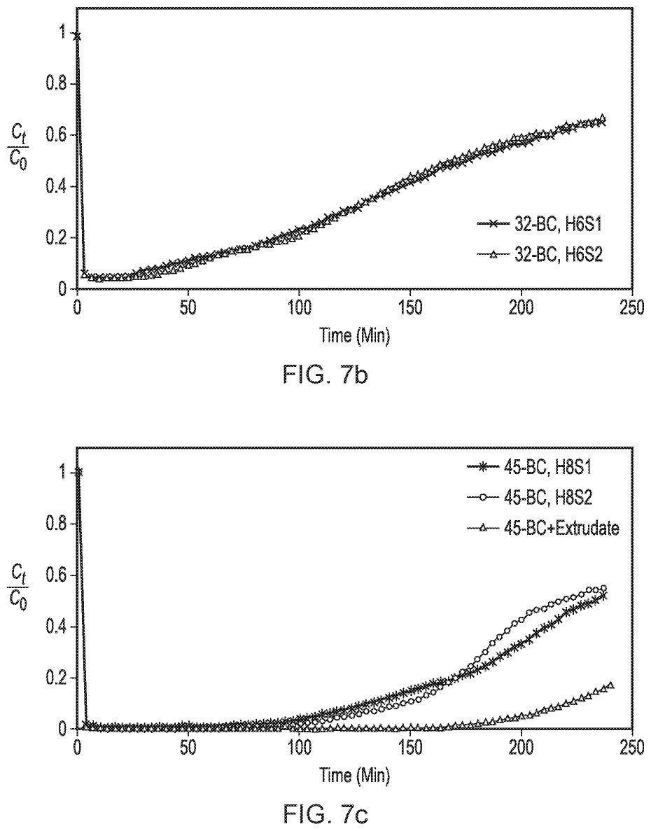

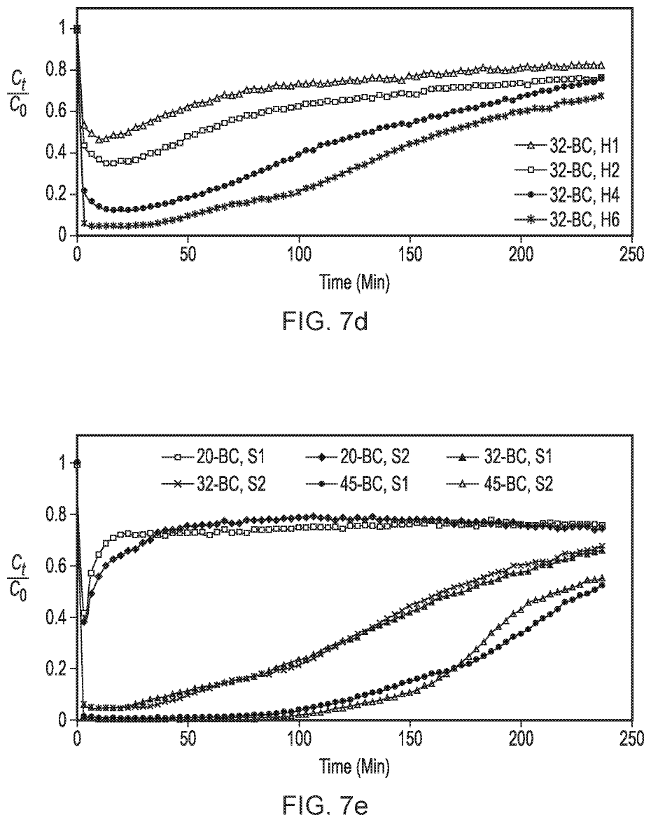

The results are presented in FIGS. 7 (a), (b) and (c). In FIGS. 7 (a)-(c), Ct is the outlet concentration of CO₂, Co is the original concentration of CO₂. FIG. 7 (d) illustrates the effect of the number of regenerating cycles on the reaction and removal of CO₂ and the observed stable bicarbonate/carbonate foam after six regeneration cycles (in accordance with Table 4, Example 5).

The results show the effect of the number of heat cycles on the breakthrough curves obtained from two samples of PI (20 wt %)/alumina (40 wt %)/KHCO₃ (40 wt %) porous matrix with the same formulation. The two samples were manufactured using the same conditions, both were regenerated at 165° C. and pre-loaded with water prior to all of the adsorption experiments (which were operated for 4 hours).

As shown in FIG. 7, the increase in operating temperature to 45° C. resulted in Ct/Co reducing to 0 which indicated that all of the CO₂ is being removed from the matrix. The experiment was performed for 4 hours in order to eliminate any accumulation of water and to protect the CO₂ analytical instrument. FIG. 7 (e) illustrates the effect of operating temperature (20-45° C.) on the reaction and removal of CO₂ and the associated performance of the carbonate foam. The figure illustrates an increase in capacity and stable reaction conditions at a temperature of 45° C. (in accordance with Table 5, Example 5).

Table 5 shows the average equilibrium loading of PI (20 wt %)/Alumina (40 wt %)/KHCO₃ (40 wt %) and bicarbonate extrudates with foam combination column, challenged with 4% vol CO₂ in air at 45° C. in four hours after seventh and eighth regeneration cycles. In Table 5, “45” indicates the operating temperature (° C.), “H” indicates the number of regeneration cycles.

TABLE 5

| Sample | ${q}_{eq} ( \frac{g {CO}_{2}}{g {K}_{2} {CO}_{3}} )$ |
|---|---|
| 45-BC, H7 | 0.18 ± 0.008 (18% wt loading) |
| 45-BC, H8 | 0.19 ± 0.007 (19% wt loading) |
| 45-BC and Extrudate | 0.157 (16% wt loading) |
| combination | |

The operating temperature (20° C. to 32° C.) had a significant effect on the CO₂ adsorption capacity for both the ceramic matrix and the polymeric/carbonate matrix. The further increment in operating temperature to 45° C. had a stronger effect on the CO₂ adsorption capacity when compared to the effect of the number of regeneration cycles (increased CO₂ loading by 36% wt). The optimum operating temperature was found to be about 45° C. An increase in the operating temperature may have increased the rate of carbonation and thus a higher adsorption capacity was achieved within the same time span (four hours). Due to the carbonation reaction being reversible and exothermic, there may be a limit to the benefits obtainable in increasing the operating temperature. Operating at a temperature greater than 60° C. caused the maximum reaction rate to increase but resulted in the conversion (K₂CO₃ to KHCO₃) rate to decrease.

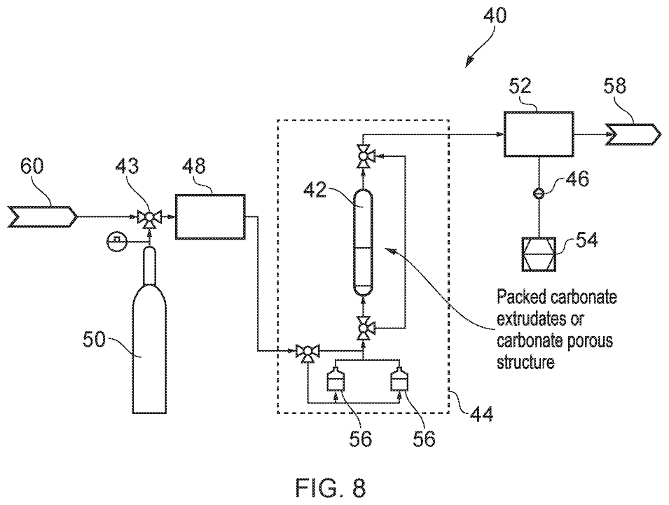

The procedure for testing a sample's ability to remove CO₂ from air is as follows and described with reference to FIG. 8.

A schematic diagram of the adsorption flow-breakthrough apparatus used to determine the sorption/reactive properties of the samples is shown in FIG. 8 and indicated generally at (40). The apparatus comprises a CO₂ sorption/reactive column (42), feed gas flow system (43) and a data logger (46) for recording the CO₂ concentration in the gas stream exiting the sorption column. The column (42) filled with matrix sample material was placed in a temperature-controlled cabinet (44). A sintered plate flow distributor was fitted prior to the inlet of the sample to help create a uniform flow distribution. A mass flow controller (MFC, e.g. Brooks Instruments, 0254) indicated at (48) was used to control the feed flow rate of CO₂ to the sorbent column. Each virgin matrix sample was exposed to the desired temperature (about 100 to about 300° C.) for a period of 24 hours and while being exposed to pure nitrogen gas flowing through a heated oven prior to sorption experiments. Polytetrafluoroethylene (PTFE) tape was used to create a seal around the ends of each matrix sample before being placed inside the column to prevent gas leakage at the wall. This ensured that the CO₂ only flowed through the matrix and not around the foam wall. Compressed CO₂ (e.g. 4%) in air (50) was directed through the humidity generators (56) until the relative humidity reached a stable level (in some cases 50%-90% RH). A compressor is indicated at (60). The CO₂ concentrations which could be removed ranged from about 400 ppm-100% v. The airflow was then directed through the CO₂ sorption column. Outlet concentration was measured using an infrared gas sensor (52) against time and breakthrough curves were plotted. A vent is indicated at (58).

An infrared gas instrument (Edinburgh Sensors) was used to monitor the column outlet CO₂ concentrations. The outlet CO₂ concentration was recorded by the computer (54) (e.g. Picolog software) via a data logger every 2 seconds. The samples being tested were challenged with 4% vol CO₂ in air for all sorption experiments. All sorption experiments were carried out with a feed gas flow rate of 500 mL min⁻¹ and at a temperature of 20° C., 32° C. or 45° C., and a pressure of 1 bar. The full matrix column dimensions were a total height of 27 cm and a diameter of 3.7 cm.

To humidify the extrudate samples, glass wool was placed between two fine metal gauzes and inserted at the bottom of the test column (42) to prevent the inlet from becoming blocked and thus improving gas mixing. The extrudates (in particulate form) were then poured into the cylindrical vessel before being strongly tapped to promote even extrudate distribution. The extrudate filled column was inserted into the rig and the CO₂ flow was directed through the bypass. Compressed air was directed through the humidity generators (56), e.g. water beakers, until the relative humidity reached a stable level (in some cases 50%-90%) and the CO₂ concentration remained stable at approximately 4% (range 400 ppm-40% v). The airflow was then directed through the CO₂ sorption column. Outlet concentration was measured against time and breakthrough curves were plotted. After the desired time limit was reached, the cylinder was removed from the rig and the mass recorded again.

Breakthrough curves generated from the adsorption experiments were used to determine parameters including breakthrough and equilibrium time as well as equilibrium loading. Breakthrough curves were created from the adsorption experiments to determine the equilibrium time, T_{eq}, and loading. The breakthrough time, T_{b}, is the time for the outlet concentration to rise above a set value (typically 1 or 5%) and the equilibrium time indicates when the outlet carbon dioxide concentration Cₜ is equal to the inlet concentration, C₀. The equilibrium loading, q_{eb}, is the total mass of CO₂ adsorbed after T_{eq}, and the capacity is the loading per mass of adsorbent in the structure.

For the avoidance of doubt, the present application extends to the subject-matter in the following numbered paragraphs:

1. A gas filter comprising an active element and a housing structure for said active element, said housing structure comprising a gas inlet and a gas outlet, said active element comprising or consisting of: a matrix material; a CO₂ sorbent; and water, wherein at least some of the CO₂ sorbent is embedded within the matrix material.

2. A gas filter according to paragraph 1, wherein the matrix material comprises, consists of, or consists essentially of a ceramic material and/or a polymer.

3. A gas filter according to any one of paragraphs 1 to 2, wherein the matrix material is a ceramic material and said ceramic material comprises an inorganic mineral.

4. A gas filter according to any one of paragraphs 2 to 3, wherein the ceramic material comprises a clay material.

5. A gas filter according to paragraph 4, wherein the clay material is selected from any one or more of kaolinite, montmorillonite-smectite, ilite, chlorite clay or clays.

6. A gas filter according to any one of paragraphs 4 to 5, wherein the clay material is selected from any one or more of clinoptalite, palygorskite, attapulgite, bentonite.

7. A gas filter according to any one of paragraphs 1 or 2, and wherein the matrix material comprises, consists of, or consists essentially of a polymer.

8. A gas filter according to paragraph 7, wherein the polymer is a foamed polymer.

9. A gas filter according to paragraph 8, wherein the foamed polymer comprises gas filled cells or pores.

10. A gas filter according to paragraph 9, wherein the gas is selected from one or more of carbon dioxide, nitrogen, or an organic gas, for example C1-C6 alkane, wherein the alkane may be unsubstituted or substituted with fluorine and/or chlorine.

11. A gas filter according to any one of paragraphs 7 to 10, wherein the polymer is a homopolymer or a copolymer.

12. A gas filter according to any one of paragraphs 7 to 11, wherein the polymer comprises one or more, or any combination of polyurethane (PU), poly(vinylpyrrolidone) (PVP), polyimide (PI), polymers of intrinsic microporosity (PIMs), polyvinylidene difluoride (PVDF), polyethersulfone (PES), cellulose or bio-degradable polymers such as polylactic acid (PLA) and poly(lactic-co-glycolic acid) (PLGA).

13. A gas filter according to any one of paragraphs 7 to 12, wherein the polymer comprises, or consists of, or consists essentially of a polyimide.

14. A gas filter according to any one of paragraphs 1 to 13, wherein the matrix material comprises mesopores and/or macropores.

15. A gas filter according to any one of paragraphs 1 to 14, wherein the CO₂ sorbent is a solid.

16. A gas filter according to any one of paragraphs 1 to 15, wherein the CO₂ sorbent is distributed throughout substantially the whole of the matrix material.

17. A gas filter according to any one of paragraphs 1 to 16, wherein the CO₂ sorbent is embedded in a non homogeneous (or random, or non-regular) manner in the matrix material.

18. A gas filter according to paragraph 17, wherein the CO₂ sorbent is also present on at least one external surface of the matrix material.

19. A gas filter according to any one of paragraphs 1 to 18, wherein the matrix material is coated with the CO₂ sorbent.

20. A gas filter according to paragraph 19, wherein the matrix material is either completely coated or partially coated.

21. A gas filter according to any one of paragraphs 1 to 20, wherein the CO₂ sorbent is selected from an alkali metal carbonate, for example one or more of K₂CO₃, Na₂CO₃, Li₂CO₃.

22. A gas filter according to any one of paragraphs 1 to 21, wherein the CO₂ sorbent consists of, consists essentially of, or comprises K₂CO₃.

23. A gas filter according to any one of paragraphs 1 to 22, wherein the water is embedded within the matrix material.

24. A gas filter according to paragraph 23, wherein the water is distributed substantially throughout the matrix material.

25. A gas filter according to any one of paragraphs 1 to 24, wherein at least some of the water or all of the water is provided by an additional solid material.

26. A gas filter according to any one of paragraphs 1 to 25, wherein at least 90 wt % of the water is provided by an additional solid material, and optionally up to about 100 wt %.

27. A gas filter according to paragraph 25 or 26, wherein the additional solid material when not comprised in the active element acts as a desiccant at a temperature of about 20-25° C., pressure of about 101 kPa, and at a humidity of about 40 to 50%.

28. A gas filter according to any one of paragraphs 25 to 27, wherein the additional solid material is particulate and is selected from one or more of aluminium oxide, zeolite, silicate, (e.g. silica gel), metal organic framework (MOF), clay, (e.g. kaolinite).

29. A gas filter according to any one of paragraphs 25 to 28, wherein the additional solid material is selected from particulate aluminium oxide (e.g. alpha alumina powder, Al₂O₃) and optionally the particle size of the aluminium oxide is less than 50 μm.

30. A gas filter according to any one of paragraphs 1 to 29, wherein the active element or matrix material comprises open channels.

31. A gas filter according to paragraph 30, wherein the open channels are about 1 mm to about 10 mm, for example about 3 mm to about 8 mm in diameter at their widest point.

32. A gas filter according to paragraph 30 or 31, wherein at least some or all of the open channels run essentially parallel to each other.

33. A gas filter according to any one of paragraphs 1 to 32, wherein the CO₂ sorbent comprises, or consists of, or consists essentially of potassium carbonate.

34. A gas filter according to any one of paragraphs 1 to 33, wherein the CO₂ sorbent is present in an amount of 5 wt % to 80 wt % based on the total weight of the active element.

35. A gas filter according to any one of paragraphs 1 to 34, wherein the matrix material is present in an amount of 20 wt % to 95 wt % based on the total weight of the active element.

36. A gas filter according to any one of paragraphs 1 to 35, wherein the water is present in an amount of 5 wt % to 40 wt % based on the total weight of the active element.

37. A gas filter according to any one of paragraphs 25 to 36, wherein the additional solid is present in an amount of 20 wt % to 60 wt % based on the total weight of the active element.

38. A gas filter according to any one of paragraphs 1 to 37, wherein the active element has been extruded and, optionally, ground.

39. A gas filter according to any one of paragraphs 1 to 38, wherein the active element is in the form of a monolithic structure.

40. A gas filter according to any one of paragraphs 1 to 38, wherein the active element is in the form of a minilithic structure.

41. A gas filter according to any one of paragraphs 1 to 40 wherein the air filter comprises more than one of said active elements.

42. A gas filter according to any one of paragraphs 1 to 40, wherein the air filter comprises only one of the active elements.

43. A gas filter according to any one of paragraphs 1 to 42, wherein the matrix material is provided as a single part.

44. A gas filter according to any one of paragraphs 1 to 43, wherein the matrix material comprises pores, for example mesopores and/or macropores, and wherein the dimensions of at least some, substantially all, or all of the pores in the matrix material possess at least one or a combination of the following:
a) a pore diameter of about 200 μm to about 600 μm, for example about 200 μm to about 500 μm;
b) an average pore diameter of about 300 μm to about 400 μm, for example about 320 μm to about 350 μm;
c) a pore window diameter of about 300 μm to about 900 μm, for example about 400 μm to about 800 μm, for example about 500 μm to about 800 μm;
d) an average pore window diameter of about 500 μm to about 800 μm, for example about 600 μm to about 700 μm.

45. A gas filter according to any one of paragraphs 1 to 44, wherein the matrix material comprises pores and said pores comprise an inner surface and a pore opening or window, and the concentration of CO₂ sorbent is greatest at, or close to, the inner surface of the pores and/or at the pore openings or windows.

46. A gas filter according to paragraph 45, wherein the concentration of CO₂ sorbent is greatest at the inner surface(s) of the pores and/or at the pore window over a combined surface area of about 50 μm² and, optionally, measured to a depth of about 1 μm when measured from the edge of an inner surface of the pores in the direction of the body of the matrix.

47. A gas filter according to any one of paragraphs 25 to 46, wherein at least some of the additional solid material is in direct contact with the sorbent, or wherein at least some of the additional solid material is within a distance of about 0.5 to about 40 μm of the nearest sorbent.

48. A gas filter according to paragraph 47, wherein at least 20 wt % of the additional solid material is within about 0.2 to about 20 μm of the nearest sorbent.

49. A gas filter according to any one of paragraphs 1 to 48, wherein the active element comprises a combination of (i) a matrix material which is a ceramic material, a CO₂ sorbent, and water wherein at least some of the CO₂ sorbent is embedded within the matrix, plus (ii) a matrix material which is a polymer, a CO₂ sorbent, and water wherein at least some of the CO₂ sorbent is embedded within the matrix.

50. A gas filter according to any one of paragraphs 1 to 49, wherein the CO₂ sorbent is present in the form of a precursor thereof, for example at least one bicarbonate.

51. A method of removing carbon dioxide from a gas stream comprising passing the gas stream through the gas filter in accordance with any one of paragraphs 1 to 50.

52. A method according to paragraph 51, wherein the gas filter or active matrix is heated in order to (re)generate the CO₂ sorbent.

53. A method according to paragraph 52, wherein the CO₂ sorbent is generated or regenerated by heating in a temperature range of about 120° C. to about 165° C.

54. A method according to any one of paragraphs 51 to 53, wherein the CO₂ sorbent is regenerated at least once, or more than once and optionally up to ten times.

55. A method according to any one of paragraphs 51 to 54, wherein the method is carried out at a temperature range of about 30° C. to about 50° C., for example about 32° C. to about 45° C., for example at about 40° C., or at about 45° C.

56. An active element suitable for use in the gas filter in accordance with paragraph 1, wherein the active element comprises or consists of: a matrix material; a CO₂ sorbent; and water, wherein at least some of the CO₂ sorbent is embedded within the matrix material.

57. An active element according to paragraph 56, wherein the active element is further characterised in accordance with any one of paragraphs 2 to 50.

58. A method of making an active element, said active element comprising or consisting of: a ceramic matrix material; a CO₂ sorbent; and water, wherein at least some of the CO₂ sorbent is embedded within the matrix material, the method comprising:
combining at least one clay material, a pore former, a CO₂ sorbent or precursor thereof, and water to form a paste, shaping the paste to form a green article, and firing the green article to form the active element.

59. A method of making an active element, said active element comprising or consisting of: a ceramic matrix material; a CO₂ sorbent; and water, wherein at least some of the CO₂ sorbent is embedded within the matrix material, the method comprising:
combining at least one clay material, a pore former, and water to form a paste, shaping the paste to form a green article, and firing the green article to form the active element, impregnating the active element with a CO₂ sorbent or precursor thereof, optionally wherein the CO₂ sorbent or precursor thereof is in solution.

60. A method of making an active element, said active element comprising or consisting of: a polymer matrix material; a CO₂ sorbent; and water, wherein at least some of the CO₂ sorbent is embedded within the matrix material, the method comprising:
forming a first mixture comprising a first monomer, a solvent for the first monomer, a first catalyst, water and optionally at least one additive;
forming a second mixture comprising a second monomer, a CO₂ sorbent or precursor thereof, a second catalyst;
combining said first and second mixtures to form said polymer matrix.

61. A method according to paragraph 60, wherein on or after combining the first and second mixtures a foaming reaction is initiated and a foaming agent is formed.

62. A method according to paragraph 61, wherein the foaming agent is CO₂.

63. A method according to any one of paragraphs 60 to 62, wherein the first monomer is an anhydride or dianhydride and the second monomer is an isocyanate or a diisocyanate.

64. A method according to any one of paragraphs 60 to 63, wherein the first monomer is selected from one or more of oxidiphthalic anhydride (ODPA), biphenyltetracarboxylic dianhydride (BPDA), pyromellitic dianhydride (PMDA), benzophenonetetracarboxylic dianhydride (BTDA), diphenylsulfonetetracarboxylic dianhydride (DSDA) and the second monomer is selected from toluene diisocyanate (TDI), or P-MDI.

65. A method according to any one of paragraphs 60 to 64, wherein the at least one additive is silicon oil, and/or the first and second catalyst are selected, independently of each other, from an amine catalyst and a tin catalyst.

66. A method according to any one of paragraphs 60 to 65, wherein the solvent is N-Methyl-2-pyrrolidone (NMP).

67. A method according to any one of paragraphs 60 to 66, wherein the polymer matrix comprises or consists of polyimide.

68. A method according to any one of paragraphs 60 to 67, wherein the polymer matrix is a foamed polymer matrix.

69. A method according to any one of paragraphs 58 to 68, wherein at least some or all of the water is provided by an additional solid material.

70. A method according to paragraph 69, wherein the additional solid material is combined (i) to form the paste in paragraph 58 or 59 or (ii) in the first and/or second mixture in paragraph 60.

71. A method according to paragraph 69 or 70, wherein the further solid material comprises or consists of one or more or any combination of aluminium oxide (e.g. Al₂O₃), zeolite, silicate, (e.g. silica gel), metal organic framework (MOF), clay, (e.g. kaolinite).

72. A method according to any one of paragraphs 58 to 71 wherein the CO₂ sorbent is combined in an active or inactive form.

73. A method according to paragraph 72, wherein the CO₂ sorbent is combined in an inactive form and the active element is heated to convert the CO₂ sorbent into an active form.

74. A method according to paragraph 72 or 73, wherein the inactive form of the CO₂ sorbent is an alkali metal bicarbonate and the active form is an alkali metal carbonate.

75. A method according to paragraph 74, wherein the alkali metal bicarbonate is potassium bicarbonate and the alkali metal carbonate is potassium carbonate.

76. A method according to any one of paragraphs 58 to 75, wherein the active element is formed into particles, for example, the active element is crushed, ground, or milled and optionally sieved.

1. A gas filter comprising an active element and a housing structure for said active element, said housing structure comprising a gas inlet and a gas outlet, said active element comprising or consisting of: a matrix material; a CO₂ sorbent; and water, wherein at least some of the CO₂ sorbent is embedded within the matrix material.

2. A gas filter according to claim 1, wherein the matrix material comprises, consists of, or consists essentially of a ceramic material and/or a polymer.

3. A gas filter according to claim 1, wherein the matrix material is a ceramic material and said ceramic material comprises an inorganic mineral.

4. A gas filter according to claim 2, wherein the ceramic material comprises a clay material.

5. A gas filter according to claim 4, wherein the clay material is selected from any one or more of kaolinite, montmorillonite-smectite, ilite, chlorite clay or clays.

6. A gas filter according to claim 4, wherein the clay material is selected from any one or more of clinoptalite, palygorskite, attapulgite, bentonite.

7. A gas filter according to claim 1, and wherein the matrix material comprises, consists of, or consists essentially of a polymer.

8. A gas filter according to claim 7, wherein the polymer is a foamed polymer.

9. A gas filter according to claim 7, wherein the polymer comprises one or more, or any combination of polyurethane (PU), poly(vinylpyrrolidone) (PVP), polyimide (PI), polymers of intrinsic microporosity (PIMs), polyvinylidene difluoride (PVDF), polyethersulfone (PES), cellulose or bio-degradable polymers such as polylactic acid (PLA) and poly(lactic-co-glycolic acid) (PLGA).

10. A gas filter according to any claim 1, wherein the polymer comprises, or consists of, or consists essentially of a polyimide.

11. A gas filter according to claim 1, wherein the matrix material comprises mesopores and/or macropores.

12. A gas filter according to claim 1, wherein the CO₂ sorbent is selected from an alkali metal carbonate, for example one or more of K₂CO₃, Na₂CO₃, Li₂CO₃.

13. A gas filter according to claim 1, wherein the water is embedded within the matrix material.

14. A gas filter according to claim 1, wherein at least some of the water or all of the water is provided by an additional solid material.

15. A gas filter according to claim 14, wherein the additional solid material is particulate and is selected from one or more of aluminium oxide, zeolite, silicate, (e.g. silica gel), metal organic framework (MOF), clay, (e.g. kaolinite).

16. A gas filter according to claim 14, wherein the additional solid material is selected from particulate aluminium oxide (e.g. alpha alumina powder, Al₂O₃) and optionally the particle size of the aluminium oxide is less than 50 μm.

17. A gas filter according to claim 1, wherein the active element comprises a combination of (i) a matrix material which is a ceramic material, a CO₂ sorbent, and water wherein at least some of the CO₂ sorbent is embedded within the matrix, plus (ii) a matrix material which is a polymer, a CO₂ sorbent, and water wherein at least some of the CO₂ sorbent is embedded within the matrix.

18. A gas filter according to claim 1, wherein the CO₂ sorbent is present in the form of a precursor thereof, for example at least one bicarbonate.

19. A method of removing carbon dioxide from a gas stream comprising passing the gas stream through the gas filter in accordance with claim 1.

20. A method according to claim 19, wherein the gas filter or active matrix is heated in order to (re)generate the CO₂ sorbent.

21. An active element suitable for use in the gas filter in accordance with claim 1, wherein the active element comprises or consists of: a matrix material; a CO₂ sorbent; and water, wherein at least some of the CO₂ sorbent is embedded within the matrix material.

22. An active element according to claim 21, wherein the active element is further characterised.

23. A method of making an active element, said active element comprising or consisting of: a ceramic matrix material; a CO₂ sorbent; and water, wherein at least some of the CO₂ sorbent is embedded within the matrix material, the method comprising:
combining at least one clay material, a pore former, a CO₂ sorbent or precursor thereof, and water to form a paste, shaping the paste to form a green article, and firing the green article to form the active element.

24. A method of making an active element, said active element comprising or consisting of: a ceramic matrix material; a CO₂ sorbent; and water, wherein at least some of the CO₂ sorbent is embedded within the matrix material, the method comprising:
combining at least one clay material, a pore former, and water to form a paste, shaping the paste to form a green article, and firing the green article to form the active element, impregnating the active element with a CO₂ sorbent or precursor thereof, optionally wherein the CO₂ sorbent or precursor thereof is in solution.

25. A method of making an active element, said active element comprising or consisting of: a polymer matrix material; a CO₂ sorbent; and water, wherein at least some of the CO₂ sorbent is embedded within the matrix material, the method comprising:
forming a first mixture comprising a first monomer, a solvent for the first monomer, a first catalyst, water and optionally at least one additive;
forming a second mixture comprising a second monomer, a CO₂ sorbent or precursor thereof, a second catalyst;
combining said first and second mixtures to form said polymer matrix.
